(19) United States
(12) Patent Application Publication
(10) Pub. No.: US 2017/0039768 A1
(43) Pub. Date: Feb. 9, 2017

(54) APPARATUS FOR DISPLAYING IMAGE CONTENT BASED ON POP-UP BOOK AND METHOD THEREOF

(71) Applicant: ELECTRONICS AND TELECOMMUNICATIONS RESEARCH INSTITUTE, Daejeon (KR)

(72) Inventors: Hang-Kee KIM, Daejeon (KR); Ki-Hong KIM, Sejong (KR); Hong-Kee KIM, Daejeon (KR); Gil-Haeng LEE, Seoul (KR)

(21) Appl. No.: 15/064,775

(22) Filed: Mar. 9, 2016

(30) Foreign Application Priority Data
Aug. 4, 2015 (KR) 10-2015-0110146

(51) Int. Cl. G06T 19/00; G09G 3/00; G06T 17/20; G06T 15/20; G06T 7/00

(52) U.S. Cl. CPC G06T 19/006; G06T 15/205; G06T 7/0051; G06T 17/20; G09G 3/003

(57) ABSTRACT

An apparatus for displaying image content based on pop-up book includes: a database for storing multiple pieces of reference depth-based mesh information, acquired for each page of pop-up book where stereoscopic shapes stand when the pop-up book is opened, and image content corresponding to each page; a depth information acquisition unit for acquiring an image including depth information by capturing the current page where the stereoscopic shapes protrude as a result of opening the pop-up book at arbitrary point, and generating depth-based mesh information about the current page; and a display unit for recognizing the current page by matching the multiple reference depth-based mesh information with the depth-based mesh information about the current page, generated by the depth information acquisition unit, extracting image content corresponding to the recognized current page from the database, and projecting it onto the current page.

### CROSS REFERENCE TO RELATED APPLICATION

This application claims the benefit of Korean Patent Application No. 10-2015-0110146, filed Aug. 4, 2015, which is hereby incorporated by reference in its entirety into this application.

### BACKGROUND OF THE INVENTION

1. Technical Field

The present invention generally relates to an apparatus and method for displaying image content based on a pop-up book. More particularly, the present invention relates to an apparatus and method for displaying image content based on a pop-up book, which make a pop-up book more realistic through an augmented reality method by recognizing each page of the pop-up book, from which three-dimensional shapes protrude, using a means for acquiring depth information and by projecting image content corresponding to the page directly on the corresponding page using a display device such as a beam projector.

2. Description of the Related Art

Generally, when infants or children, who are sensitive to all objects, learn the name of a certain object or receive education, it is important to arouse their interest and curiosity in the object or the education. To this end, parents or teachers use various kinds of books, training aids, and the like.

A common children's book consists of pictures and text for a story, and in particular, a pop-up book, from which characters or items protrude in order to increase realism when it is opened, has been developed.

As an attempt to integrate digital content such as voice or video into a pop-up book, Korean Patent Application Publication No. 10-2012-0023269 (publication date: Mar. 13, 2012), titled “Smart-up book for promoting tour content and management system thereof” discloses a smart-up book for promoting tour content in which a pop-up function of a pop-up book and a function of storing digital information are implemented together.

However, according to Korean Patent Application Publication No. 10-2012-0023269 and the like, a 2-dimensional barcode for accessing information (voice and video information) related to a stereoscopic shape (tour content) protruding from a pop-up book is displayed on one side of each page of the pop-up book, and when the 2-dimensional barcode is scanned using a user's terminal, the corresponding information is displayed on the user's terminal rather than the pop-up book. Therefore, it is difficult to create a synergistic effect between the image content and the stereoscopic shapes in the pop-up book, which is open in real space.

Meanwhile, technology for Augmented Reality (AR) content, such as Korean Patent No. 10-1126449 (publication date: Mar. 29, 2012), titled “System and method for augmented reality service” and the like, has been developed. This conventional technology for augmented-reality content uses a method in which, when a marker installed in the real space is captured using a camera, the position of the user is estimated using the size or gradient of the marker, a virtual image object is combined with an actual image based on the estimated position, and the combined image content is provided to a user through a display means such as a TV or a mobile terminal. However, because the augmented reality image is displayed on the screen of an additional display device or a mobile terminal rather than on a desired object, which exists in the real space, the users' feeling of immersion in the augmented reality may decrease. In connection with this, Korean Patent Application Publication No. 10-2012-0023269 discloses a technology related to “Smart-up book for promoting tour content and management system thereof” and Korean Patent No. 10-1126449 discloses a technology related to “System and method for augmented reality service.”

### SUMMARY OF THE INVENTION

An object of the present invention is to provide realistic image content service based on a pop-up book to a user by projecting image content corresponding to a pop-up book directly on the pop-up book in the real space, from which three-dimensional shapes protrude.

Another object of the present invention is to provide image content service based on a pop-up book that enables a user to be immersed in the scenario of a pop-up book by overcoming the limitations of a conventional pop-up book, in which the story on each page may be experienced only through the protrusion of previously printed content or the manipulation of simple items, and by projecting video content onto each page of the pop-up book using a display means.

In order to accomplish the above object, an apparatus for displaying image content based on a pop-up book according to the present invention includes: a database for storing multiple pieces of reference depth-based mesh information that are acquired in advance for each page of a pop-up book, on which a stereoscopic shape stands when the pop-up book is open, and image content corresponding to each page; a depth information acquisition unit for acquiring an image that includes depth information by capturing a current page on which a stereoscopic shape of the pop-up book stands and for generating depth-based mesh information about the current page, the pop-up book being located at an arbitrary point and opened; and a display unit for recognizing the current page by matching the multiple pieces of reference depth-based mesh information, stored in advance in the database, with the depth-based mesh information about the current page, generated by the depth information acquisition unit, for extracting image content corresponding to the recognized current page from the database, and for projecting the extracted image content onto the current page.

The display unit may include a page recognition unit for matching the depth-based mesh information about the current page with reference depth-based mesh information that has a highest similarity to the depth-based mesh information about the current page among the multiple pieces of reference depth-based mesh information by using an Iterative Closest Point (ICP) algorithm or an active contour algorithm and for recognizing a page corresponding to the matched reference depth-based mesh information as the current page.

The multiple pieces of reference depth-based mesh information, stored in the database, may be reference depth-based information for each page of the pop-up book in a state of being open while being located at a fixed point (reference point), and the image content corresponding to each page may be image content projected on each page of the pop-up book in a state of being open while being located at the fixed point (reference point).

The reference depth-based mesh information for each page, stored in the database, may include reference depth-based mesh information that is acquired in advance when the pop-up book is located at the fixed point (reference point) and is open to a specific angle.

The display unit may further include a disparity information generation unit for comparing the reference depth-based mesh information corresponding to the current page that is recognized by the page recognition unit with the depth-based mesh information about the current page, generated by the depth information acquisition unit, and thereby calculating affine transformation information between the current page of the pop-up book in the state of being open while being located at the fixed point (reference point) and the current page of the pop-up book that is open while being located at the arbitrary point.

The display unit may further include an image content projection unit for transforming the reference depth-based mesh information corresponding to the current page based on the affine transformation information, calculated by the disparity information generation unit, in order to correspond to the depth-based mesh information about the current page, generated by the depth information acquisition unit, and for rendering and projecting image content corresponding to the current page depending on the transformed reference depth-based mesh information in order to be projected onto the current page of the pop-up book that is open while being located at the arbitrary point.

The display unit may further include a preprocessing unit for calculating a position-related parameter, which pertains to a relative position between the depth information acquisition unit and the display unit, and a rendering parameter, which enables image content corresponding to the current page to be projected onto the current page of the pop-up book, of which an image is acquired by the depth information acquisition unit, and for performing calibration between the depth information acquisition unit and the display unit based on the calculated position-related parameter and the calculated rendering parameter.

The position-related parameter may be a shift and rotation transformation matrix for representing a relative position between the depth information acquisition unit and the display unit.

The image content corresponding to each page, stored in the database, may be image content that is interconnected with image content corresponding to previous and next pages based on a single scenario.

The depth information acquisition unit may generate depth-based mesh information about a current page of the pop-up book, in which a marker does not exist, and the display unit may project image content corresponding to a current page directly onto a surface of the current page of the pop-up book

Also, in order to accomplish the above object, a method for displaying image content based on a pop-up book includes: (1) acquiring, by a depth information acquisition unit, an image that includes depth information by capturing a current page on which a stereoscopic shape of a pop-up book stands, the pop-up book being located at an arbitrary point and opened; (2) generating, by the depth information acquisition unit, depth-based mesh information about the current page from the image that includes the depth information; (3) recognizing, by a display unit, the current page by matching multiple pieces of reference depth-based mesh information, acquired in advance for each page of the pop-up book and stored in a database, with the depth-based mesh information about the current page, generated in (2); and (4) by the display unit, extracting image content corresponding to the current page recognized in (3) from the database in which image content corresponding to each page is stored, and projecting the extracted image content onto the current page of the pop-up book, which is located at the arbitrary point and is open.

In (3), the depth-based mesh information about the current page may be matched with reference depth-based mesh information that has a highest similarity to the depth-based mesh information about the current page among the multiple pieces of reference depth-based mesh information by using an Iterative Closest Point (ICP) algorithm or an active contour algorithm, and a page corresponding to the matched reference depth-based mesh information may be recognized as a current page.

The multiple pieces of reference depth-based mesh information, stored in the database, may be reference depth-based information for each page of the pop-up book in a state of being open while being located at a fixed point (reference point), and the image content corresponding to each page may be image content projected on each page of the pop-up book in a state of being open while being located at the fixed point (reference point).

The reference depth-based mesh information for each page, stored in the database, may include reference depth-based mesh information that is acquired in advance when the pop-up book is located at the fixed point (reference point) and is open to a specific angle.

(4) may include, (4-1) comparing the reference depth-based mesh information corresponding to the current page recognized in (3) with the depth-based mesh information about the current page, generated in (2), and thereby calculating affine transformation information between the current page of the pop-up book in a state of being open while being located at the fixed point (reference point) and the current page of the pop-up hook, which is open while being located at the arbitrary point.

(4) may further include, (4-2) transforming the reference depth-based mesh information corresponding to the current page based on the affine transformation information calculated in (4-1) in order to correspond to the depth-based mesh information about the current page, generated in (2), and rendering and projecting image content corresponding to the current page depending on the transformed reference depth-based mesh information in order to be projected onto the current page of the pop-up book, which is open while being located at the arbitrary point.

The method for displaying image content based on a pop-up book may further include preprocessing before (1), wherein preprocessing may be configured to calculate a position-related parameter, which pertains to a relative position between the depth information acquisition unit and the display unit, and a rendering parameter, which enables image content corresponding to the current page to be projected onto the current page of the pop-up book, of which an image is acquired by the depth information acquisition unit, and to perform calibration between the depth information acquisition unit and the display unit based on the calculated position-related parameter and the calculated rendering parameter.

The position-related parameter may be a shift and rotation transformation matrix for representing a relative position between the depth information acquisition unit and the display unit.

The image content corresponding to each page, stored in the database, may be image content that is interconnected with image content corresponding to previous and next pages based on a single scenario.

In (2), depth-based mesh information about a current page of the pop-up book in which a marker does not exist may be generated, and in (4), image content corresponding to a current page may be projected directly onto a surface of the current page of the pop-up book,

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating the concept of the configuration and operation of an apparatus for displaying image content based on a pop-up book according to the present invention;

FIG. 2 is a view illustrating the case in which the left and right pages of a pop-up book are open at various angles;

FIG. 3 is a block diagram illustrating the configuration of the display unit, shown in FIG. 1, in detail;

FIG. 4 is a flowchart illustrating a method for displaying image content based on a pop-up book according to the present invention; and

FIG. 5 is a flowchart illustrating step S500, shown in FIG. 4, in detail.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, the configuration and operation of the apparatus for displaying image content based on a pop-up book according to the present invention will be described.

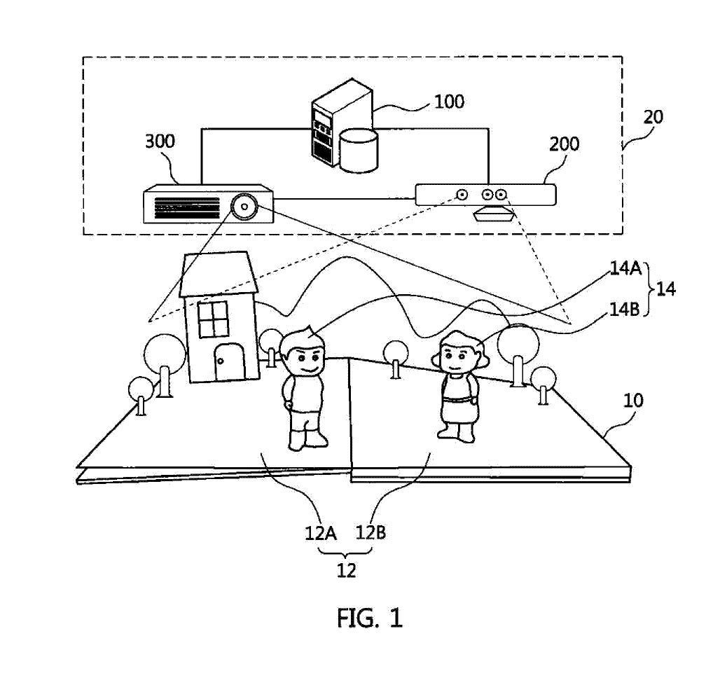

FIG. 1 is a view illustrating the concept of the configuration and operation of the apparatus for displaying image content based on a pop-up book according to the present invention.

Referring to FIG. 1, the apparatus for displaying image content based on a pop-up book 20 includes a database 100 for acquiring and storing in advance, reference depth-based mesh information for each page of a pop-up book 10 from which a three-dimensional stereoscopic shape 14 (14a, 14b) protrudes when opened, and storing image content to be projected onto each page when the corresponding page is opened, a depth information acquisition unit 200 for acquiring an image that includes depth information by capturing the current page 12 (12a, 12b) of the pop-up book 10, which is open while being located at an arbitrary point in real space, and generating depth-based mesh information about the current page 12; a display unit 300 for recognizing the current page 12 by matching the reference depth-based mesh information for each page, stored in the database 100, with the depth-based mesh information about the current page 12, generated by the depth information acquisition unit 200, extracting image content corresponding to the recognized current page 12 from the database 100, and projecting the image content onto the current page 12 of the pop-up book 10 in real space. In the present invention, each page of the pop-up book from which depth-based mesh information is acquired does not include an additional marker.

First, the database 100 stores depth-based mesh information for each page, which is acquired in advance under the condition that a pop-up book 10, from which one or more stereoscopic shapes 14 (14a, 14h) rise up when each page is opened, is open while being located at a reference point, which is a fixed location in real space. In this case, multiple pieces of depth-based mesh information, acquired in advance for each page, may be depth-based mesh information that is generated through the processes of locating the pop-up book 10 at the fixed point (reference point) in real space and acquiring an image that includes depth information by capturing each page using the depth information acquisition unit 200 of the apparatus for displaying image content based on a pop-up book 20 according to the present invention. However, the method for acquiring depth-based mesh information for each page is not limited to the above-mentioned method. Hereinafter, the depth-based mesh information for each page of the pop-up book 10, stored in advance in the database 100, is called reference depth-based mesh information. Here, in order to enable the display unit 300, which will be described later, to more correctly recognize the current page based on the reference depth-based mesh information for each page of the pop-up book 10, stored in advance in the database 100, it is desirable for the stereoscopic shape 14 (14a, 14b) that protrudes from each page of the pop-up book 10 to have a different shape and size depending on the page.

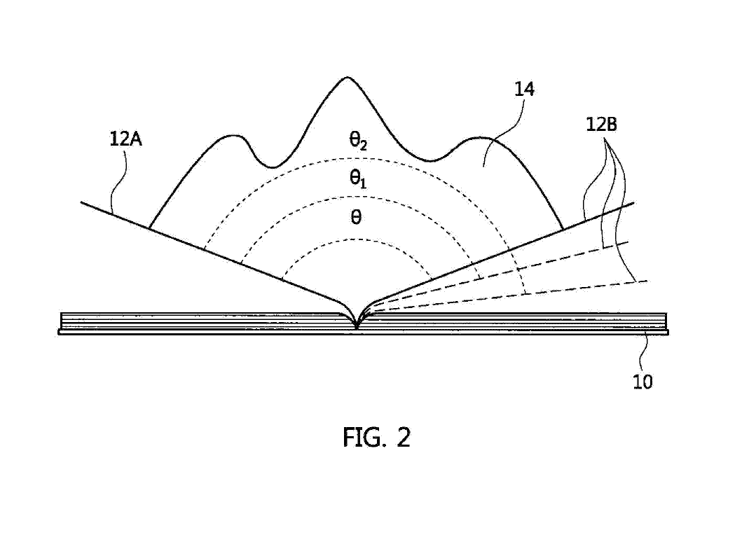

The reference depth-based mesh information, which is acquired in advance for the case where the pop-up book 10 is located at a fixed point (reference point) in real space and is stored in the database 100, may be a single piece of reference depth-based mesh information corresponding to each page, or may alternatively comprise two or more pieces of depth-based mesh information corresponding to a single page. More specifically, as will be described later, the reference depth-based mesh information for each page of the pop-up book 10, stored in the database 100, is used to recognize the current page 12 by being compared with the depth-based mesh information that is acquired when a user opens the corresponding pop-up book 10 to the current page 12 at an arbitrary point in real space. In this case, when the user opens the pop-up book 10 to a certain page, the angle between the left and right pages 12a and 12b may vary, as θ, θ₁, θ₂, etc. (for example, 160°, 140°, 120°, etc.) as shown in FIG. 2, rather than be 180° by fully opening the pop-up book to make the left and right pages 12a and 12b form a plane. Accordingly, in order for the display unit 300 to correctly recognize the current page 12 (12a, 12b) of the pop-up book 10, which may be open at various angles (θ, ₁, θ2, etc.), the database 100 may store reference depth-based mesh information based on each angle for each page, which is acquired in advance when the pop-up book 10 is open in such a way that the angle between the left and right pages becomes a certain angle (Δθ).

Also, the database 100 stores image content corresponding to each page of the pop-up book 10. More specifically, because the image content to be projected by the display unit may differ according to the page, the image content to be projected for each page is stored in advance in the database 100. In this case, if the pop-up book 10 deals with a single continuous scenario, the image content corresponding to each page, stored in the database 100, may be interconnected with image content corresponding to the previous and next pages based on the continuous scenario. The image content corresponding to each page may be not only animated movies but also still images, and may include appropriate sound (background music, narration, sound effects, and the like) for the projected movies or still images. Here, the image content corresponding to each page is image content to be projected on each page of the pop-up book 10, open while being located at a fixed point (reference point) in real space, and may be represented as a render texture material type, which is animated on the surface of the reference depth-based mesh. Meanwhile, each page of the pop-up book 10 may be divided into a part on which image content is projected and a remaining part, on which image content is not projected. Here, the part on which image content is not projected may be designed in advance to have images and the like, and it is desirable for the part on which image content is projected to be made of a material that may reflect the picture, projected by the display unit 300, as brightly as possible, or for it to be coated with such a material.

The depth information acquisition unit 200 acquires an image that includes depth information by capturing the current page 12 (12a, 12b) on which a stereoscopic shape protrudes as a result of opening the pop-up book 10 located at an arbitrary point in real space. Then, depth-based mesh information about the current page 12 (12a, 12b) is generated from the obtained image that includes the depth information. Here, desirably, the depth-information acquisition unit 200 may be a single depth camera, which may sense a depth image for an object located in front of it, such as a Kinect, Structure 10, or the like, or may alternatively be a multi-view camera, which acquires three-dimensional information by performing stereo matching of an obtained image. The depth information acquisition unit 200 transmits the generated depth-based mesh information about the current page 12 (12a, 12b) to the display unit 300. Meanwhile, if an item movable by a user (for example, a rotary plate, etc.) is attached to a page of the pop-up book 10, when the corresponding item is moved by the manipulation by the user, the depth information acquisition unit 200 may trace the depth image pertaining thereto and transmit the traced depth image information to the display unit 300.

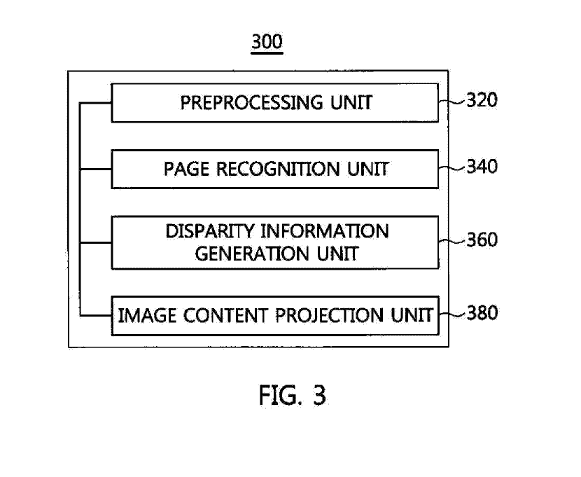

The display unit 300 recognizes the current page 12 (12a, 12b) by matching multiple pieces of reference depth-based mesh information, stored in advance in the database 100, with the depth-based mesh information about the current page 12 (12a, 12b), generated by the depth information acquisition unit 200, extracts image content corresponding to the recognized current page 12 (12a, 12b) from the database 100, and projects the image content onto the current page 12 (12a, 12b). More specifically, as illustrated in FIG. 3, the display unit 300 includes a preprocessing unit 320, a page recognition unit 340, a disparity information generation unit 360, and an image content projection unit 380.

Before the display unit 300 extracts image content corresponding to the recognized current page 12 (12a, 12b) from the database 100 and projects it onto the current page 12 (12a, 12b), calibration between the depth information acquisition unit 200 and the display unit 300, which are arranged in real space, must be performed as a preprocessing process. To this end, the preprocessing unit 320 calculates a position-related parameter, which pertains to the relative position between the depth information acquisition unit 200 and the display unit 300, and a rendering parameter, which enables image content corresponding to the current page 12 (12a, 12b) to be projected on the current page 12 (12a, 12b) of the pop-up book 10, the image of which is acquired by the depth information acquisition unit 200, and performs calibration between the depth information acquisition unit 200 and the display unit 300 based on the calculated position-related parameter and the calculated rendering parameter. In the case of a conventional method of displaying an image using a projector, after calibration has been completed, if the object onto which the image is projected is moved or rotated or if the projector is moved, the image cannot be correctly projected onto the surface of the desired object. However, the present invention performs calibration based on the position-related parameter pertaining to the relative positions of the depth information acquisition unit 200 and the display unit 300 and checks, in real time, whether the depth-based mesh information about the current page 12 (12a, 12b) matches the reference depth-based mesh information so as to project image content onto the surface of the current page 12 (12a, 12b) of the pop-up book 10. Therefore, unless the calibrated depth information acquisition unit 200 and display unit 300 are moved or rotated individually, image content corresponding to the page may be correctly projected onto the surface of the corresponding page of the pop-up book 10, the depth image of which is acquired by the depth information acquisition unit 200 in real space. In this case, the position-related parameter, calculated by the preprocessing unit 320, may be a shift and rotation transformation matrix, which represents the relative position between the depth information acquisition unit 200 and the display unit 300.

The page recognition unit 340 extracts reference depth-based mesh information for each page of the pop-up book 10 from the database 100 and recognizes the current page 12 (12a, 12b) to which the pop-up book 10 is open while being located at an arbitrary point in real space by comparing the reference depth-based mesh information for each page of the pop-up book 10 with the depth-based mesh information about the current page 12 (12a, 12b) of the pop-up book 10, which is generated by the depth information acquisition unit 200. To this end, the page recognition unit 340 matches the depth-based mesh information about the current page with the reference depth-based mesh information that has the highest similarity to the depth-based mesh information about the current page 12 (12a, 12b), generated by the depth information acquisition unit 200, among the multiple pieces of reference depth-based mesh information extracted from the database 100, by applying an Iterative Closest Point (ICP) algorithm or an active contour (snake) algorithm, and then recognizes the page corresponding to the matched reference depth-based mesh information as the current page. In other words, alter tracing the iterative closest point (ICP) or the contour (a part in which the difference between depths is high) of both the depth-based mesh structure of the current page 12 (12a, 12b), generated by the depth information acquisition unit 200, and the reference depth-based mesh structure for each page, extracted from the database 100, the page recognition unit 340 performs a similarity comparison using the active contour and recognizes the page corresponding to the reference depth-based mesh structure that has the highest similarity as the current page 12 (12a, 12b) of the pop-up book 10, which is located at the arbitrary location. Here, if the ICP algorithm is applied, the following processes are performed for similarity comparison. First, the same number of points are selected through sampling respectively from the depth-based mesh structure of the current page 12 (12a, 12b), generated by the depth information acquisition unit 200, and from the reference depth-based mesh structure of each page, extracted from the database 100, and points having the shortest distance therebetween are matched with each other for the two sets of points selected by sampling. Then, a three-dimensional transformation matrix for minimizing the distances between the matched points, included in the two sets, is calculated, the sum of distances between the points, matched through the three-dimensional transformation matrix, which is an error value, is calculated, and the error value is compared with a predetermined threshold value, whereby the similarity comparison is performed. Also, in the present invention, it is desirable to use an ICP algorithm in order to recognize the location and orientation of the current page 12 (12a, 12b) of the pop-up book 10. This is because this algorithm has advantages in matching the reference depth-based mesh that has the highest similarity to the depth-based mesh of the current page 12 (12a, 12b) and deriving affine transformation information, which enables the disparity information generation unit 360 to detect how the depth-bawd mesh of the current page 12 (12a, 12b) in real space is shifted or rotated relative to the corresponding reference depth-based mesh, which will be described later.

The disparity information generation unit 360 compares the reference depth-based mesh information corresponding to the current page 12 (12a, 12b), which is recognized by the page recognition unit 340, with the depth-based mesh information generated by the depth information acquisition unit 200, and calculates affine transformation information between the current page 12 (12a, 12b) of the pop-up book 10 in the state of being open while being located at a fixed point (reference point) and the current page 12 (12a, 12b) of the pop-up book 10, which is open while being located at the arbitrary point. The disparity information generation unit 360 transmits the calculated affine transformation information about the current page 12 (12a, 12b) of the pop-up book 10 to the image content projection unit 380.

Based on the affine transformation information received from the disparity information generation unit 360, the image content projection unit 380 transforms the reference depth-based mesh information corresponding to the current page 12 (12a, 12b) in order to correspond to the depth-based mesh information about the current page 12 (12a, 12b), generated by the depth information acquisition unit 200. Then, in order to project image content corresponding to the current page 12 (12a, 12b) onto the current page 12 (12a, 12b) of the pop-up book 10, which is open while being located at the arbitrary point, the image content projection unit 380 renders the corresponding image content depending on the transformed reference depth-based mesh information, and then projects it. Consequently, in the present invention, the image projection unit 380 projects image content corresponding to the current page directly on the surface of the current page of the pop-up book.

Hereinafter, a method for displaying image content based on a pop-up book according to the present invention is described. Repeated descriptions of the operation of the apparatus for displaying image content based on a pop-up book according to the present invention, which have been made with reference to FIGS. 1 to 3, will be omitted.

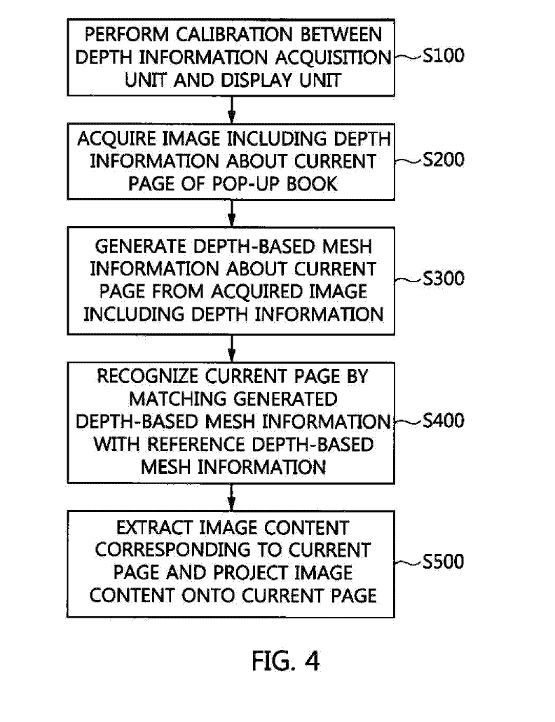

FIG. 4 is a flowchart illustrating the method for displaying image content based on a pop-up book according to the present invention.

Referring to FIG. 4, in the method for displaying image content based on a pop-up book according to the present invention, first, calibration between the depth information acquisition unit 200 and the display unit 300, which are arranged in real space, is performed as a preprocessing process at step S100. At step S100, the preprocessing unit 320 of the display unit 300 calculates a position-related parameter, which pertains to the relative position between the depth information acquisition unit 200 and the display unit 300, and a rendering parameter, which enables image content corresponding to the current page 12 (12a, 12b) to be projected onto the current page 12 (12a, 12b) of the pop-up book 10, the image of which is acquired by the depth information acquisition unit 200, and performs calibration between the depth information acquisition unit 200 and the display unit 300 based on the calculated position-related parameter and the calculated rendering parameter.

After the calibration between the depth information acquisition unit 200 and the display unit 300 is performed as a preprocessing process at step 100, when a user opens the pop-up book 10 at an arbitrary point in real space, the depth information acquisition unit 200 acquires an image that includes depth information at step S200 (first phase) by capturing the current page 12 (12a, 12b), on which a stereoscopic shape 14 (14a, 14b) protrudes as a result of opening the pop-up book 10 at the arbitrary point. Then, the depth information acquisition unit 200 generates the depth-based mesh information about the current page 12 (12a, 12b) at step S300 (second phase) by analyzing the depth image for the current page 12 (12a, 12b) of the pop-up book 10, acquired at step S200. Also, at step S300, the depth information acquisition unit 200 transmits the generated depth-based mesh information about the current page 12 (12a, 12b) to the display unit 300.

The display unit 300 recognizes the corresponding current page 12 (12a, 12b) at step S400 (third phase) by matching the depth-based mesh information about the current page 12 (12a, 12b), received from the depth information acquisition unit 200 at step S300, with multiple pieces of reference depth-based mesh information, which are acquired for each page of the pop-up book 10 in advance and stored in the database 100. At step S400, the page recognition unit 340 of the display unit 300 matches the depth-based mesh information about the current page with the reference depth-based mesh information that has the highest similarity to the depth-based mesh information about the current page 12 (12a, 12b), generated by the depth information acquisition unit 200, among the multiple pieces of reference depth-based mesh information extracted from the database 100 by using an ICP algorithm or an active contour algorithm, and then recognizes the page corresponding to the matched reference depth-based mesh information as the current page 12 (12a, 12b).

Subsequently, at step S500 (fourth phase), the display unit 300 extracts image content corresponding to the current page 12 (12a, 12b), recognized at step S400, from the database 100, in which image content corresponding to each page is stored, and projects the extracted image content onto the surface of the current page 12 (12a, 12b) of the pop-up book 10, which is open while being located at the arbitrary point in real space.

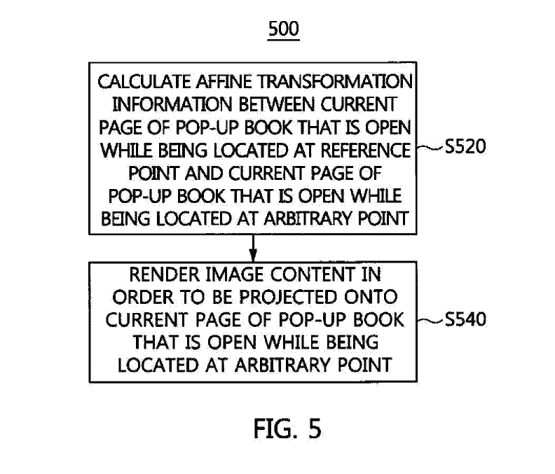

FIG. 5 is a flowchart for specifically describing step S500 of the flowchart of the method for displaying image content based on a pop-up book according to the present invention, illustrated in FIG. 4.

Referring to FIG. 5, at step S500, in which the display unit 300 extracts image content corresponding to the current page 12 (12a, 12b) from the database 100 and projects it onto the surface of the current page 12 (12a, 12b) of the pop-up book 10, which is open while being located at the arbitrary point in real space, first, the disparity information generation unit 360 of the display unit 300 compares the reference depth.. based mesh information corresponding to the current page 12 (12a, 12b), stored in the database 100, with the depth-based mesh information about the current page 12 (12a, 12b), generated by the depth information acquisition unit 200 at step S300. Then, based on the result of the comparison, the disparity information generation unit 360 calculates affine transformation information between the current page 12 (12a, 12b) of the pop-up book 10 in the state of being open at a fixed point (reference point) and the current page 12 (12a, 12b) of the pop-up book 10, which is open while being located at the arbitrary point, at step S520 (4-1-th phase).

Subsequently, based on the affine transformation information calculated at step S520, the image content projection unit 380 of the display unit 300 transforms the reference depth-based mesh corresponding to the current page 12 (12a, 12b) in order to correspond to the depth-based mesh of the current page 12 (12a, 12b) of the pop-up book 10, which is open while being located at the arbitrary point in real space. Then, in order for the image content corresponding to the current page 12 (12a, 12b), extracted from the database 100, to be projected onto the current page 12 (12a, 12b) of the pop-up book 10, which is open while being located at the arbitrary point in real space, the image content projection unit 380 renders the corresponding image content depending on the transformed reference depth-based mesh information and projects it at step S540 (4-2-th phase).

According to the present invention, the limitation of conventional technology for augmented-reality content based on a marker, in which image content is limited to being displayed on the screen of a mobile terminal, whereby the user's feeling of immersion decreases, is solved, and image content corresponding to a pop-up book is projected by a display means such as a beam projector directly on the pop-up book in the real space, on which three-dimensional shapes protrude, whereby more realistic image content service based on a pop-up book may be provided to a user.

Also, according to the present invention, a pop-up book is recognized by matching a depth image that is acquired from the actual pop-up book in real space with reference depth-based mesh information, and image content corresponding to the recognized pop-up book is projected, whereby augmented reality image content may be provided to a user without installing or recognizing a marker in the real space, as in the conventional technology for augmented-reality content based on a marker.

Also, according to the present invention, the limitations of a conventional pop-up book, in which the story of each page may be experienced only through the protrusion of previously printed Content or the manipulation of simple items, is overcome, and image content using a display means is projected onto each page of the pop-up book, whereby image content service based on a pop-up book, which enables a user to be immersed in the scenario of the pop-up book, may be provided.

As described above, optimal embodiments of the present invention have been disclosed in the drawings and the specification. Although specific terms have been used in the present specification, these are merely intended to describe the present invention, and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for displaying image content based on a pop-up book, comprising:
a database for storing multiple pieces of reference depth-based mesh information that are acquired in advance for each page of a pop-up book, on which a stereoscopic shape stands when the pop-up book is open, and image content corresponding to each page;
a depth information acquisition unit for acquiring an image that includes depth information by capturing a current page on which a stereoscopic shape of the pop-up book stands and for generating depth-based mesh information about the current page, the pop-up book being located at an arbitrary point and opened; and
a display unit for recognizing the current page by matching the multiple pieces of reference depth-based mesh information, stored in advance in the database, with the depth-based mesh information about the current page, generated by the depth information acquisition unit, for extracting image content corresponding to the recognized current page from the database, and for projecting the extracted image content onto the current page.

2. The apparatus of claim 1, wherein the display unit comprises a page recognition unit for matching the depth-based mesh information about the current page with reference depth-based mesh information that has a highest similarity to the depth-based mesh information about the current page among the multiple pieces of reference depth-based mesh information by using an Iterative Closest Point (ICP) algorithm or an active contour algorithm and for recognizing a page corresponding to the matched reference depth-based mesh information as the current page.

3. The apparatus of claim 2, wherein the multiple pieces of reference depth-based mesh information, stored in the database, are reference depth-based information for each page of the pop-up book in a state of being open while being located at a fixed point (reference point); and
the image content corresponding to each page is image content projected on each page of the pop-up book in a state of being open while being located at the reference point.

4. The apparatus of claim 3, wherein the reference depth-based mesh information for each page, stored in the database, comprises reference depth-based mesh information that is acquired in advance when the pop-up book is located at the reference point and is open to a specific angle.

5. The apparatus of claim 3, wherein the display unit further comprises a disparity information generation unit for comparing the reference depth-based mesh information corresponding to the current page that is recognized by the page recognition unit with the depth-based mesh information about the current page, generated by the depth information acquisition unit, and thereby calculating affine transformation information between the current page of the pop-up book in the state of being open while being located at the reference point and the current page of the pop-up book that is open while being located at the arbitrary point.

6. The apparatus of claim 5, wherein the display unit further comprises an image content projection unit for transforming the reference depth-based mesh information corresponding to the current page based on the affine transformation information, calculated by the disparity information generation unit, in order to correspond to the depth-based mesh information about the current page, generated by the depth information acquisition unit, and for rendering and projecting image content corresponding to the current page depending on the transformed reference depth-based mesh information in order to be projected onto the current page of the pop-up book that is open while being located at the arbitrary point.

7. The apparatus of claim 6, wherein the display unit further comprises a preprocessing unit for calculating a position-related parameter, which pertains to a relative position between the depth information acquisition unit and the display unit, and a rendering parameter, which enables image content corresponding to the current page to be projected onto the current page of the pop-up book, of which an image is acquired by the depth information acquisition unit, and for performing calibration between the depth information acquisition unit and the display unit based on the calculated position-related parameter and the calculated rendering parameter.

8. The apparatus of claim 7, wherein the position -related parameter is a shift and rotation transformation matrix for representing a relative position between the depth information acquisition unit and the display unit.

9. The apparatus of claim 1, wherein the image content corresponding to each page, stored in the database, is image content that is interconnected with image content corresponding to previous and next pages based on a single scenario.

10. The apparatus of claim 1, wherein:
the depth information acquisition unit generates depth-based mesh information about a current page of the pop-up book, in which a marker does not exist, and
the display unit projects image content corresponding to a current page directly onto a surface of the current page of the pop-up book.

11. A method for displaying image content based on a pop-up book, comprising:
acquiring, by a depth information acquisition unit, an image that includes depth information by capturing a current page on which a stereoscopic shape of a pop-up book stands, the pop-up book being located at an arbitrary point and opened;
generating, by the depth information acquisition unit, depth-based mesh information about the current page from the image that includes the depth information;
recognizing, by a display unit, the current page by matching multiple pieces of reference depth-based mesh information, acquired in advance for each page of the pop-up book and stored in a database, with the generated depth-based mesh information about the current page; and
by the display unit, extracting image content corresponding to the recognized current page from the database in which image content corresponding to each page is stored, and projecting the extracted image content onto the current page of the pop-up book, which is located at the arbitrary point and is open.

12. The method of claim 11, wherein recognizing, by a display unit, the current page by matching multiple pieces of reference depth-based mesh information, acquired in advance for each page of the pop-up book and stored in a database, with the generated depth-based mesh information about the current page comprising:
the depth-based mesh information about the current page is matched with reference depth-based mesh information that has a highest similarity to the depth-based mesh information about the current page among the multiple pieces of reference depth-based mesh information by using an Iterative Closest Point (ICP) algorithm or an active contour algorithm, and a page corresponding to the matched reference depth-based mesh information is recognized as a current page.

13. The method of claim 12, wherein the multiple pieces of reference depth-based mesh information, stored in the database, are reference depth-based information for each page of the pop-up book in a state of being open while being located at a reference point; and
the image content corresponding to each page is image content projected on each page of the pop-up book in a state of being open while being located at the reference point.

14. The method of claim 13, wherein the reference depth-based mesh information for each page, stored in the database, comprises reference depth-based mesh information that is acquired in advance when the pop-up book is located at the reference point) and is open to a specific angle.

15. The method of claim 14, wherein by the display unit, extracting image content corresponding to the recognized current page from the database in which image content corresponding to each page is stored, and projecting the extracted image content onto the current page of the pop-up book, which is located at the arbitrary point and is open comprising:
comparing the reference depth-based mesh information corresponding to the recognized current page with the depth-based mesh information about the generated current page and thereby calculating affine transformation information between the current page of the pop-up book in a state of being open while being located at the reference point and the current page of the pop-up book, which is open while being located at the arbitrary point.

16. The method of claim 15, whereinby the display unit, extracting image content corresponding to the recognized current page from the database in which image content corresponding to each page is stored, and projecting the extracted image content onto the current page of the pop-up book, which is located at the arbitrary point and is open further comprising:
transforming the reference depth-based mesh information corresponding to the current page based on the calculated affine transformation information in order to correspond to the depth-based mesh information about the generated current page, and rendering and projecting image content corresponding to the current page depending on the transformed reference depth-based mesh information in order to be projected onto the current page of the pop-up book, which is open while being located at the arbitrary point.

17. The method of claim 16, further comprising,
preprocessing before acquiring, by a depth information acquisition unit, an image that includes depth information by capturing a current page on which a stereoscopic shape of a pop-up book stands, the pop-up book being located at an arbitrary point and opened,
wherein preprocessing is configured to:
calculate a position-related parameter, which pertains to a relative position between the depth information acquisition unit and the display unit, and a rendering parameter, which enables image content corresponding to the current page to be projected onto the current page of the pop-up book, of which an image is acquired by the depth information acquisition unit; and
perform calibration between the depth information acquisition unit and the display unit based on the calculated position-related parameter and the calculated rendering parameter.

18. The method of claim 17, wherein the position-related parameter is a shift and rotation transformation matrix for representing a relative position between the depth information acquisition unit and the display unit.

19. The method of claim 11, wherein the image content corresponding to each page, stored in the database, is image content that is interconnected with image content corresponding to previous and next pages based on a single scenario.

20. The method of claim 11, wherein generating, by the depth information acquisition unit, depth-based mesh information about the current page from the image that includes the depth information, the depth-based mesh information about a current page of the pop-up book in which a marker does not exist is generated; and
by the display unit, extracting image content corresponding to the recognized current page from the database in which image content corresponding to each page is stored, and projecting the extracted image content onto the current page of the pop-up book, which is located at the arbitrary point and is open, the image content corresponding to a current page is projected directly onto a surface of the current page of the pop-up book.
